(19) United States
(12) Patent Application Publication
(10) Pub. No.: US 2006/0165745 A1
(43) Pub. Date: Jul. 27, 2006

(54) Sustained release tablets for treatment of aqueous environment and methods for making the same

(76) Inventors: Yiwen Chew, Singapore (SG); Yi Xin Chew, Singapore (SG)

Correspondence Address: LAWRENCE Y.D. HO & ASSOCIATES PTE LTD, 30 BIDEFORD ROAD, #07-01, THONGSIA BUILDING, SINGAPORE, 229922, SG

(21) Appl. No.: 11/038,078

(22) Filed: Jan. 21, 2005

(51) Int. Cl. A01N 25/00

(52) U.S. Cl. 424/405

(57) ABSTRACT

The present invention provides tablets for treatment of aqueous environment that release at least one active ingredient in a sustained manner so as to provide the treated aqueous environment with the at least one active ingredient for a long period with a single dose. The present invention also provides methods for making the sustained release tablets.

### FIELD OF THE INVENTION

The present invention relates to tablets for treatment of aqueous environment that release at least one active ingredient in a sustained manner so as to provide the treated aqueous environment with the at least one active ingredient for a long period with a single dose. The present invention also relates to the methods for making the sustained release tablets.

### BACKGROUND OF THE INVENTION

Aqueous environment can be formed in natural resources and artificial places. For examples, puddles or small ponds may be formed in lower grounds directly from the rain or underground water. On the other hand, water may be retained in any containers or pools or tubes. The exemplary ones include water based paints, pulp and paper mills, fresh water supply systems, cooling towers, swimming pools and spas.

Usually, aqueous environment enables within it the growth of bacteria, yeast, fungi and algae. In addition, the aqueous environment may be a breeding place for many dangerous insects. For example, the mosquito spreading Denge fever virus breeds in small water puddles in pots, sewages or bathtubs. Furthermore, the aqueous environment needs to be treated to prevent scale deposition, corrosion of metal surface and similar fouling of water treatment systems, as well to maintain proper pH levels.

In some occasions, compositions containing active ingredients such as anti-foulants, anti-scaling agents, corrosion inhibitors, buffering and pH agents, microcides and the like may be added directly to aqueous environment for treatment. At the same time, sustained release biocide products are well known and are used in many home and commercial fields where they are employed in the killing of, inhibition of, or control of the growth of bacteria, yeast, fungi and algae.

The sustained release products usually employ a coating to encapsulate the active ingredients so as to control the release of the active ingredient by the coating. For example, U.S. Pat. No. 6,607,694 discloses a controlled release additive composition for use in water treatment systems, particularly coolant and hot water systems. The disclosed composition comprises a water-soluble core containing at least one water treatment chemical and a polymeric coating material encapsulating said core which slowly releases the water treatment chemical into the water treatment system. It is apparent that the release rate is controlled by the water insoluble polymeric coating.

U.S. Pat. No. 4,800,082 discloses a sustained release microbiological control composition containing a hydrophilic polymer and a halogenated amide as the active ingredient. It was claimed that the tablets made of the forementioned compositions retained activity for approximately 21 days. However, this document did not measure the concentrations of the active ingredient released in the investigation period. In stead, it measured the active ingredient by planktonic plate counts. This indirect measurement failed to demonstrate that the composition had a truly sustained release rather than showing that a minimum amount of the halogenated amide enough for reducing the planktonic plate counts was existed at the end of the investigation period. It is apparent that the compositions provided by this document are not applicable in situations in which a truly sustained release is required. For example, a burst of the active ingredient at the beginning may release too much of the active ingredient so as to danger the handlers or other people who have contacts with the treated aqueous environment. Furthermore, the inventors of the present application have observed an immediate disintegration of the tablets following the teachings of this U.S. patent.

Therefore, there is an imperative need to have tablets that deliver active ingredients in a sustained manner into aqueous environments and methods for making the tablets. This invention satisfies this need by disclosing the tablets for treatment of aqueous environment that release at least one active ingredient in a sustained manner so as to provide the treated aqueous environment with the at least one active ingredient for a long period with a single dose. The present invention also provides the methods for making the sustained release tablets. Other advantages of this invention will be apparent with reference to the detailed description.

### SUMMARY OF THE INVENTION

The present invention provides tablets that deliver active ingredients in a sustained manner into aqueous environments and methods for making the tablets. In one aspect, the present invention provides a tablet that comprises at least one water soluble polymer in the range of 0.1-80% w/w, and at least one active ingredient in the range of 0.1-95.5% w/w, whereby all the ingredients of said tablet are thoroughly admixed and formed into the tablet; wherein the formed tablet is cured to have water in the range of 0.1-30% w/w before it is applied to the water-based environment so that the at least one active ingredient will be released into the water-based environment in a sustained manner. In one embodiment, the formed tablet is cured by steaming the tablets unwrapped for a specified time in accordance with the size and dimension of the tablets and the type of the polymer used. In another embodiment, the formed tablet is cured by leaving the tablets unwrapped in an ambient environment with humidity for a specified time in accordance with the size and dimension of the tablets and the type of the polymer used. In yet another embodiment, the at least one water soluble polymer is selected from the group consisting of cellulose, ethylene oxides; HMPC, MHPC, HEMC, MHEC, HEC, HPC, CMC, and Na-CMC. In yet still another embodiment, the at least one active ingredient may be pesticides, insecticides, toxicants, insect growth regulators, plant growth regulators, microbial control agents, bioactive control agents, parasites, bactericides, viricides, fungicides, algaecides, herbicides, nematicides, amoebicides, acaricides, miticides, predicides, schistisomicides, molluscicides, larvicides, pupicides, ovicides, adulticides, nymphicides, attractants, repellents, growth stimulants, feeding stimulants, nutrients, hormones, chemosterilants, or pheromones, fragrances, flavorants, food additives, inorganic chemicals, organic chemicals and combinations thereof. In addition, the tablet may optionally comprises a binder, a die release agent, a compression agent, a floating agent, a sinking agent or an adhering agent.

In another aspect, the present invention provides a tablet that comprises at least one water soluble polymer in the range of 0.1-80% w/w, at least one active ingredient in the range of 0.1-95.5% w/w, and water in the range of 0.1-30% w/w; whereby all the ingredients of said tablet are thoroughly admixed and formed into the tablet; wherein the formed tablet is cured before it is applied to the water-based environment so that the at least one active ingredient will be released into the water-based environment in a sustained manner. In one embodiment, the water may be added either in the form of pure water, water contained within the water-soluble polymer, or water contained within the active ingredient. In another embodiment, the formed tablet is cured by wrapping up the tablet and leaving the wrapped tablet in an environment with an ambient temperature for a specified time in accordance with the size and dimension of the tablets and the type of the polymer used. In yet another embodiment, the formed tablet is cured by wrapping up the tablet and heating the wrapped tablet for a specified time in accordance with the size and dimension of the tablets and the type of the polymer used.

In yet another aspect, the present invention provides a tablet for controlled release of at least one active ingredient into a water-based environment, wherein the tablet has two or more layers; and wherein each layer may have the same or different water-soluble polymer or active ingredients; each layer of said tablet comprising at least one water soluble polymer in the range of 0.1-80% w/w, and at least one active ingredient in the range of 0.1-95.5% w/w; whereby all the ingredients of said tablet are thoroughly admixed and formed into one layer of the tablet, and a first layer will be encapsulated by another layer; wherein the formed tablet is cured to have water in the range of 0.1-30% w/w before it is applied to the water-based environment so that the at least one active ingredient will be released into the water-based environment in a sustained manner.

In further another aspect, the present invention provides a tablet that comprises at least one nature water-soluble polymer in the range of 0.1-5% w/w, at least one active ingredient in the range of 0.1-60% w/w, and water in the range of 50-99% w/w; wherein the at least one nature water-soluble polymer is melted in the water and admixed with the at least one active ingredient, and then the admixed components are cast into the tablet. In one embodiment, the nature water-soluble polymer is selected from the group consisting of gelatin, maltodextrin, xanthan gum and carrageenan.

In still another aspect, the present invention provides a method for manufacturing a tablet for controlled release of at least one active ingredient into a water-based environment, wherein the tablet comprises at least one water-soluble polymer in the range of 0.1-80% w/w; and at least one active ingredient in the range of 0.1-95.5% w/w; said method comprising the following steps of admixing thoroughly of all the components including the at least one water soluble polymer and the at least one active ingredient, compacting the admixture into tablet, and curing the tablet so that the tablet may have water in the range of 0.1-30% w/w before it is applied to the water-based environment so that the at least one active ingredient will be released into the water-based environment in a sustained manner. In one embodiment, the curing step is done by steaming the tablets unwrapped for a specified time in accordance with the size and dimension of the tablets and the type of the polymer used. In another embodiment, the curing step is done by leaving the tablets unwrapped in an ambient environment with humidity for a specified time in accordance with the size and dimension of the tablets and the type of the polymer used.

In yet still another aspect, the present invention provides a method for manufacturing a tablet for controlled release of at least one active ingredient into a water-based environment, wherein the tablet comprises at least one water soluble polymer in the range of 0.1-80% w/w; at least one active ingredient in the range of 0.1-95.5% w/w; and water in the range of 0.1-30% w/w; said method comprising the following steps of admixing thoroughly of all the components including the at least one water soluble polymer, the at least one active ingredient thoroughly, and water; compacting the admixture into tablet; and curing the tablet before it is applied to the water-based environment so that the at least one active ingredient will be released into the water-based environment in a sustained manner. In one embodiment, the water may be added either in the form of pure water, water contained within the water-soluble polymer, or water contained within the active ingredient. In another embodiment, the curing step includes wrapping up the tablets and leaving the wrapped tablets in an environment with an ambient temperature for a specified time in accordance with the size and dimension of the tablets and the type of the polymer used. In yet another embodiment, the curing step includes wrapping up the tablets and heating the wrapped tablets for a specified time in accordance with the size and dimension of the tablets and the type of the polymer used.

The objectives and advantages of the invention will become apparent from the following detailed description of preferred embodiments thereof in connection with the accompanying drawings.

### BRIEF DESCRIPTION OF THE DRAWINGS

Preferred embodiments according to the present invention will now be described with reference to the Figures, in which like reference numerals denote like elements.

FIG. 1 is an illustrative diagram showing one possible process of the controlled release of active ingredients from the tablet into water.

FIG. 2a and FIG. 2b show the release profiles of the copper ions concentration in the testing water from and the weight loss of the tablet manufactured in accordance with Example 1 in an actual field test over a 30-day period.

### DETAILED DESCRIPTION OF THE INVENTION

The present invention may be understood more readily by reference to the following detailed description of certain embodiments of the invention.

Throughout this application, where publications are referenced, the disclosures of these publications are hereby incorporated by reference, in their entireties, into this application in order to more fully describe the state of art to which this invention pertains.

The present invention provides tablets for treating an aqueous environment by providing a sustained release of at least one active ingredient over a relatively long period. As defined herein, the “tablet” refers to any compositions in accordance with the present invention, wherein the tablet may take on any form, shape or dimension depending on its specific application. For example, the tablet may be in the form of solid compact or gel in strip and tube form, and in the shape of ball or puck,

The tablets comprise at least one water-soluble polymer. The exemplary water-soluble polymers include cellulose, ethylene oxides; HMPC, MHPC, HEMC, MHEC, HEC, HPC, CMC, and Na-CMC. The above mentioned water-soluble cellulose ethers are ones which by partial substitution of alcohol group which are glucose group in the cellulose, form methyl ether, hydroxypropyl ether and/or hydroxyethyl ether and that are soluble in water. Examples of the above mentioned water-soluble cellulose ethers are methylcellulose, hydroxypropylcellulose, hydroxypropylmehylcellulose, etc. Methoxyl group in the methylcellulose is preferably 26.0 to 33.0%. In the hydroxypropylcellulose (abbreviated to HPC), hydroxypropoxyl group is preferably 53.4 to 77.5%. In the hydroxypropylmethylcellulose (abbreviated to HPMC), methoxyl and hydroxypropoxyl groups are preferably 19.0 to 30.0% and 4.0 to 12.0%.

In addition to the above listed water soluble cellulosic polymers, other natural and synthetic hydrophilic polymers such as gelatin, maltodextrin, xanthan gum and carrageenan, and synthetic hydrophilic polymers such as carboxymethyl guar, hydroxypropyl guar, carboxymethyl galactomannose, polyvinyl acetate and polyvinylpyrrolidone are also suitable for use in preparing the tablets of the present invention. It is also contemplated that mixtures of the above listed polymers can be so employed and such mixtures are within the scope of the present invention.

The tablets also comprise at least one active ingredient. As defined herein, the “active ingredient” used in the present application refers to any chemical, material or substance that has at least one function desired by the user. The active ingredient shall not produce any chemical reactions within the tablet so as to impair the desired function of the active ingredient or the release of the active ingredient when it is admixed with the at least one water-soluble polymer to form the tablet. The exemplary active ingredients include pesticides, insecticides, toxicants, insect growth regulators, plant growth regulators, microbial control agents, bioactive control agents, parasites, bactericides, viricides, fungicides, algaecides, herbicides, nematicides, amoebicides, acaricides, miticides, predicides, schistisomicides, molluscicides, larvicides, pupicides, ovicides, adulticides, nymphicides, attractants, repellents, growth stimulants, feeding stimulants, nutrients, hormones, chemosterilants, or pheromones, fragrances, flavorants, food additives and combinations thereof, such as the two, three or four component combinations. Two or more bioactive agents can be combined in the same composition to achieve multi functional performance from a single application.

General bioactive materials include Bacillus thuringiensis, and especially subspecies kurstaki and israelensis, Bacillus sphaericus, Bacillus popilliae, Seriatia marcescens, and Lagenidium giganteum. Fungal larvicides may also be employed such as Lagenidium giganteum mycelium or Lagenidium giganteum oospores or mixtures thereof. Fungal materials can also be effective against mosquito larvae. Waste treatment bacteria, grease degrading bacteria. Insect growth regulators can be used such as (S)-methoprene, diflubenzuron, or pyriproxyfen. Compositions and processes for control of various species of mosquitoes, and other pest dipterans in aquatic habitats are of particular interest. Other insecticides may also be employed including products such as malathion, resmethrin, dichlorvos, bendiocarb, fenitrothion or chlorpyrifos. Insecticides such as pyrethrin and pyrethroid can be effective as larvicides for mosquitoes. Various herbicides that may be employed, especially effective aquatic herbicides include Amitrole®, ammonium sulfamate, Bromacil®, copper salts, dalapon, Dichlorbenil®, Diquat®, Diuron®, Endothall®, Fenac®, Picloram®, Prometon®, Silvex®, Simazine®, trichloroacetic acid, 2,4-D, 2,4,5-T, Velpar®, TSMA, dicamba, endothall, silvex, prometon, chlorate, sodium metaborate, monuron, and various combinations thereof, such as the two, three or four component combinations.

Control of floating and submersed aquatic weeds is also of special interest. Bioactive agents included in the compositions and processes for these applications include acrolein, aromatic solvents (xylene), copper sulfate and other water soluble copper salts or compounds, dalapon, dichlorbenil, 2,4-D, diquat, endothall, glyphosate, simazine, and fluridone, and combinations thereof, such as the two, three or four component combinations.

It should be noted that any bioactive agent (any inorganic chemicals or organic chemicals), and combinations thereof, such as the two, three or four component combinations, designed for promoting, enhancing (e.g., nutrients, flavorants, medicaments) or terminating (e.g., pesticides, or herbicides) the life of aquatic or terrestrial organisms can be utilized in the compositions of matter, depending on the desired end result.

The active ingredient also includes: (1) buffers to maintain the desired degree of acidity/alkalinity, e.g., a neutral or alkaline pH, including for example, alkali metal phosphates, borates and the like and mixtures thereof; (2) cavitation liner pitting inhibitors including alkali metal nitrites, molybdates and the like and mixtures thereof; (3) metal corrosion inhibitors and/or hot surface corrosion inhibitors including alkali metal nitrates and silicates, carboxylic acids, phosphonic acids, phosphonates, pyrophosphates, azoles, sulfonic acids, mercaptobenzothiazoles, metal dithiophosphates, metal dithiocarbonates, phenolic anti-oxidants including 4,4°″-methylenebis(2,6-di-tertbutylphenol that is commercially available under the trademark Ethyl 702 by Ethyl Corporation) and the like and mixtures thereof; and (4) hot surface deposition inhibitors and/or scale inhibitors including phosphate esters, phosphino carboxylic acids, polyacrylates, styrene-maleic anhydride copolymers, sulfonates and the like and mixtures thereof.

The tablets may optionally comprise a binder. Suitable binder includes, for example, polyvinyl pyrrolidone, sdium acrylate, sodium polyacrylate, carboxymethylcellulose, sodium carboxyinethylcellulose, coren starch, microcrystalline cellulose, propylene glycol, ethylene glycol, sodium silicate, potassium silicate, methacrylate/acrylate copolymers, sodium lignosulfonate, sodium hydroxypropylcellulose.

The tablets may optionally comprise a die release agent. Suitable die release agents include, for example, calcium stearate, magnesium stearate, zinc stearate, stearic acid, propylene glycol, ethylene glycol, polyethylene glycol, polypropylene glycol, polyoxypropylene-polyoxyethyleen block copolymers, microcrystalline cellulose, kaolin, attapulgite, magnesium carbonate, fumed silica, magnesium silicate, calcium silicate, silicones, mono- and dicarboxylic acids and core starch.

The tablets may optionally comprise compression agents. The particular compression agent used is not critical and can be any suitable compression agent known in the art that is compatible with the other ingredients. Examples of suitable compression agents include dicalcium phosphate, lactose, sodium phosphate and calcium sulfate dihydrate.

The tablets may optionally comprise a floating agent, a sinking agent or an adhering agent. Any substance with density<1 may be employed as the floating agent. Similarly, any substance with density>1 may be utilized as the sinking agent. By the same token, any substance that can adhere the tablet onto the surface to a water container may be used as the adhering agent. All the agents herein shall be compatible with the polymer and active ingredients within the tablet.

The tablets can be in a variety of shapes such as, for example, cylindrical oval, square, rectangle or spherical, strips, tubes, film. The size of the tablets will vary over a wide range depending upon the particular application and the particular quantities of ingredients and the only limitation placed on the size of the tablets are the limitations of the production equipment employed.

The tablets may be manufactured by any known methods. In one embodiment of the present invention, at least water-soluble polymer and at least one active ingredient are admixed and made into the tablets. The means and equipments for admixing the polymer and active ingredient may be any known admixture apparatus. The parameters for admixing are dependent upon the chemical structures of the components. In the formation of the tablets, the methods will vary in accordance with the components. For example, when cellulose polymers are used as the water-soluble polymers, the admixed components may be compacted into tablets by using known apparatus. If the water-soluble polymers are nature polymers such as gelatin and carrageenan, the admixtures of all the components will be cast into tablets.

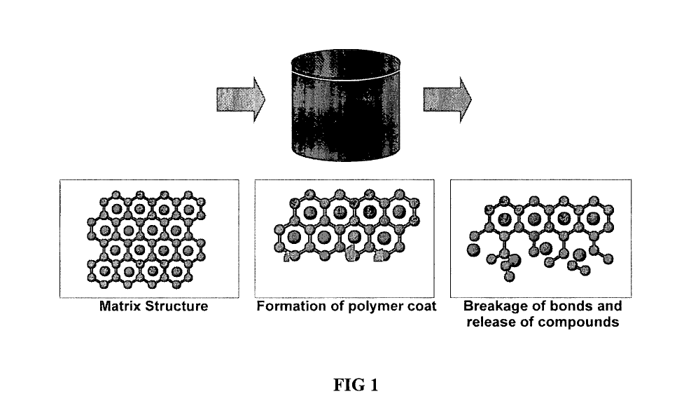

The inventors of the present application discovered that the tablet containing at least one water-soluble polymer that was admixed with at least one active ingredient would be disintegrated when it was applied to water environment if the tablet was not treated properly after the formation of the tablet. However, when the newly formed tablets went to different post-formation treatments, the tablets would not disintegrated when applied to water environment and more importantly would release the active ingredients in a sustained manner for a prolonged period. The post-tablet formation treatments will be referred to as “curing”. The curing will be dependent upon the nature of the polymers and active ingredients used in the formation of the tablets. As will be seen in later detailed examples, the curing may depend upon the water content in the formation of the tablets. Of course, the water could be added directly to the mixture of the polymer and active ingredients. The water may also be brought into the mixture by the polymer or the active ingredients. Or the water may be incorporated into the tablet after the formation by different means including steaming. Without wishing to limit the invention to any particular mechanism or theory of operation, it is believed that the controlled release of active ingredients from the tablet into the aqueous environment involves a continuous real-time coating process: the water soluble polymers swell and form a coating around the tablet when submerged into water; and when the coating gradually dissolves to release active ingredients, the next layer of the tablet is exposed so that the water soluble polymers within the next layer swells to form another coating, resulting in controlled release of active ingredients. This hypothetical process is illustrated in FIG. 1.

It is to be appreciated that the concept of post-tablet formation treatment (“curing”) may not be limited to the water content of the tablet. Other chemicals may be incorporated into the tablets so that the tablets become of sustained release nature. Also different methods for incorporating the chemicals into the formed tablets may be applicable in the present invention.

The following non-limiting examples illustrate certain aspects of the present invention.

### EXAMPLE 1

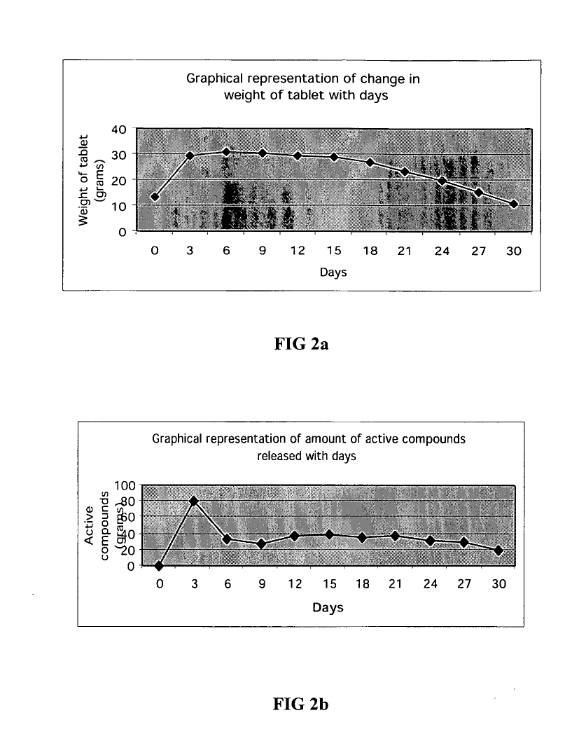

The components for making the tablet are CuAcetate pentahydrate (CAP, active ingredient) and hydroxymethylpropylcellulose (HMPC, water soluble polymer). 70 parts of CAP, 30 parts of dried HMPC and 1 part of water were admixed. 500 g of material was milled and mixed using planetary ball mill at 200 rpm for 1 hr, achieving homogeneous blend and particle size<200 um, and tabletised using laboratory scale press with die size of 50 mm and tonnage of 25 tons. When the tablets were submerged into water immediately after the tabletization, they disintegrated in water. When the tablets were wrapped in plastic bags and heated for 5 hrs at 60° C., the post-tabletization treated tablets showed excellent controlled long-term release. After the tablet was submerged into the water, the release of the CuAcetate pentahydrate (CAP) was monitored daily with measurement of the copper ions concentration in the water. Copper ions were measured by HACH copper test kit. FIG. 2a shows the weight changes of the tested tablet in one actual field test of the CAP-HMPC tablet within a 30-day period. FIG. 2b shows the copper ions concentration in one actual field test of the CAP-HMPC tablet within a 30-day period. The copper ions concentration was measured either by reagents or HPLC.

### EXAMPLE 2

All components for the tablets were the same as used in Example 1. The ratios of the admixture of all components were the same as used in Example 1 except that the water was increased into 10 parts. The results were the same as shown in Example 1.

### EXAMPLE 3

The active ingredient and water-soluble polymer for the making the tablet were the same as used in Examples 1 and 2. The admixture was done without addition of water. The tablet was made with the same conditions as discussed above. The dry tablet disintegrated in the water if the tablet was submerged into the water immediately after the production. The dry tablet was either exposed to high humidity ambient environment for a prolonged period such as one week or steamed at 60° C. for five hours. Then the post-tabletization treated tablets showed excellent results under the test conditions as discussed above.

### EXAMPLE 4

The active ingredient and water soluble polymer for the making the tablet are the same as used in Examples 1 and 2. However, the PC used had a 10% moisture content before the admixture step. 70 parts of CAP and 30 parts of moisturized HMPC were admixed and tabletized. If the tablets were submerged immediately after the production, they disintegrated in the water. If the tablets were heated for 5 hours at 60° C., the post-tabletization treated tablets showed excellent results similar to the ones discussed above.

While the present invention has been described with reference to particular embodiments, it will be understood that the embodiments are illustrative and that the invention scope is not so limited. Alternative embodiments of the present invention will become apparent to those having ordinary skill in the art to which the present invention pertains. Such alternate embodiments are considered to be encompassed within the spirit and scope of the present invention. Accordingly, the scope of the present invention is described by the appended claims and is supported by the foregoing description.

What is claimed is:

1. A tablet for controlled release of at least one active ingredient into a water-based environment, said tablet comprising:
at least one water soluble polymer in the range of 0.1-80% w/w; and
at least one active ingredient in the range of 0.1-95.5% w/w;
whereby all the ingredients of said tablet are thoroughly admixed and formed into the tablet; wherein the formed tablet is cured to have water in the range of 0.1-30% w/w before it is applied to the water-based environment so that the at least one active ingredient will be released into the water-based environment in a sustained manner.

2. The tablet of claim 1, wherein the formed tablet is cured by steaming the tablets unwrapped for a specified time in accordance with the size and dimension of the tablets and the type of the polymer used.

3. The tablet of claim 1, wherein the formed tablet is cured by leaving the tablets unwrapped in an ambient environment with humidity for a specified time in accordance with the size and dimension of the tablets and the type of the polymer used.

4. The tablet of claim 1, wherein the at least one water soluble polymer is selected from the group consisting of cellulose, ethylene oxides; HMPC, MHPC, HEMC, MHEC, HEC, HPC, CMC, and Na-CMC.

5. The tablet of claim 1, wherein the at least one active ingredient may be pesticides, insecticides, toxicants, insect growth regulators, plant growth regulators, microbial control agents, bioactive control agents, parasites, bactericides, viricides, fungicides, algaecides, herbicides, nematicides, amoebicides, acaricides, miticides, predicides, schistisomicides, molluscicides, larvicides, pupicides, ovicides, adulticides, nymphicides, attractants, repellents, growth stimulants, feeding stimulants, nutrients, hormones, chemosterilants, or pheromones, fragrances, flavorants, food additives, inorganic chemicals, organic chemicals and combinations thereof.

6. The tablet of claim 1, further optionally comprises a binder; wherein the binder ma be selected from the group consisting of polyvinyl pyrrolidone, sdium acrylate, sodium polyacrylate, carboxymethylcellulose, sodium carboxyinethylcellulose, corn starch, microcrystalline cellulose, propylene glycol, ethylene glycol, sodium silicate, potassium silicate, methacrylate/acrylate copolymers, sodium lignosulfonate, sodium hydroxypropylcellulose.

7. The tablet of claim 1, further optionally comprises a die release agent; wherein the die release agent is selected from the group consisting of calcium stearate, magnesium stearate, zinc stearate, stearic acid, propylene glycol, ethylene glycol, polyethylene glycol, polypropylene glycol, polyoxypropylene-polyoxyethyleen block copolymers, microcrystalline cellulose, kaolin, attapulgite, magnesium carbonate, fumed silica, magnesium silicate, calcium silicate, silicones, mono- and dicarboxylic acids and core starch.

8. The tablet of claim 1, further optionally comprises a compression agent; wherein the compression agent may be dicalcium phosphate, lactose, sodium phosphate and calcium sulfate dihydrate.

9. The tablet of claim 1, further optionally comprises a floating agent, a sinking agent or an adhering agent; wherein the density of the floating agent is less than 1 g/ml, the density of the sinking agent is more than 1 g/ml, and the adhering agent is able to allow the tablet to adhere to the surface of a container with water to be treated.

10. A tablet for controlled release of at least one active ingredient into a water-based environment, said tablet comprising:
at least one water soluble polymer in the range of 0.1-80% w/w;
at least one active ingredient in the range of 0.1-95.5% w/w; and
water in the range of 0.1-30% w/w;
whereby all the ingredients of said tablet are thoroughly admixed and formed into the tablet; wherein the formed tablet is cured before it is applied to the water-based environment so that the at least one active ingredient will be released into the water-based environment in a sustained manner.

11. The tablet of claim 10, wherein the water may be added either in the form of pure water, water contained within the water-soluble polymer, or water contained within the active ingredient.

12. The tablet of claim 11, wherein the formed tablet is cured by wrapping up the tablet and leaving the wrapped tablet in an environment with an ambient temperature for a specified time in accordance with the size and dimension of the tablets and the type of the polymer used.

13. The method of claim 11, wherein the formed tablet is cured by wrapping up the tablet and heating the wrapped tablet for a specified time in accordance with the size and dimension of the tablets and the type of the polymer used.

14. The tablet of claim 10, wherein the at least one water soluble polymer is selected from the group consisting of cellulose, ethylene oxides; HMPC, MHPC, HEMC, MHEC, HEC, HPC, CMC, and Na-CMC.

15. The tablet of claim 10, wherein the at least one active ingredient may be pesticides, insecticides, toxicants, insect growth regulators, plant growth regulators, microbial control agents, bioactive control agents, parasites, bactericides, viricides, fungicides, algaecides, herbicides, nematicides, amoebicides, acaricides, miticides, predicides, schistisomicides, molluscicides, larvicides, pupicides, ovicides, adulticides, nymphicides, attractants, repellents, growth stimulants, feeding stimulants, nutrients, hormones, chemosterilants, or pheromones, fragrances, flavorants, food additives, inorganic chemicals, organic chemicals and combinations thereof.

16. The tablet of claim 10, further optionally comprises a binder; wherein the binder ma be selected from the group consisting of polyvinyl pyrrolidone, sodium acrylate, sodium polyacrylate, carboxymethylcellulose, sodium carboxyinethylcellulose, coren starch, microcrystalline cellulose, propylene glycol, ethylene glycol, sodium silicate, potassium silicate, methacrylate/acrylate copolymers, sodium lignosulfonate, sodium hydroxypropylcellulose.

17. The tablet of claim 10, further optionally comprises a die release agent; wherein the die release agent is selected from the group consisting of calcium stearate, magnesium stearate, zinc stearate, stearic acid, propylene glycol, ethylene glycol, polyethylene glycol, polypropylene glycol, polyoxypropylene-polyoxyethyleen block copolymers, microcrystalline cellulose, kaolin, attapulgite, magnesium carbonate, fumed silica, magnesium silicate, calcium silicate, silicones, mono- and dicarboxylic acids and core starch.

18. The tablet of claim 10, further optionally comprises a compression agent; wherein the compression agent may be dicalcium phosphate, lactose, sodium phosphate and calcium sulfate dihydrate.

19. The tablet of claim 10, further optionally comprises a floating agent, a sinking agent or an adhering agent; wherein the density of the floating agent is less than 1 g/ml, the density of the sinking agent is more than 1 g/ml, and the adhering agent is able to allow the tablet to adhere to the surface of a container with water to be treated.

20. A tablet for controlled release of at least one active ingredient into a water-based environment, wherein the tablet has two or more layers; and wherein each layer may have the same or different water-soluble polymer or active ingredients; each layer of said tablet comprising:
at least one water soluble polymer in the range of 0.1-80% w/w; and
at least one active ingredient in the range of 0.1-95.5% w/w;
whereby all the ingredients of said tablet are thoroughly admixed and formed into one layer of the tablet, and a first layer will be encapsulated by another layer; wherein the formed tablet is cured to have water in the range of 0.1-30% w/w before it is applied to the water-based environment so that the at least one active ingredient will be released into the water-based environment in a sustained manner.

21. A tablet for controlled release of at least one active ingredient into a water-based environment, said tablet comprising:
at least one nature water-soluble polymer in the range of 0.1-5% w/w;
at least one active ingredient in the range of 0.1-60% w/w; and
water in the range of 50-99% w/w;
wherein the at least one nature water-soluble polymer is melted in the water and admixed with the at least one active ingredient, and then the admixed components are cast into the tablet.

22. The tablet of claim 21, wherein the nature water-soluble polymer is selected from the group consisting of gelatin, maltodextrin, xanthan gum and carrageenan.

23. The tablet of claim 21, wherein the at least one active ingredient may be pesticides, insecticides, toxicants, insect growth regulators, plant growth regulators, microbial control agents, bioactive control agents, parasites, bactericides, viricides, fungicides, algaecides, herbicides, nematicides, amoebicides, acaricides, miticides, predicides, schistisomicides, molluscicides, larvicides, pupicides, ovicides, adulticides, nymphicides, attractants, repellents, growth stimulants, feeding stimulants, nutrients, hormones, chemosterilants, or pheromones, fragrances, flavorants, food additives, inorganic chemicals, organic chemicals and combinations thereof.

24. A method for manufacturing a tablet for controlled release of at least one active ingredient into a water-based environment, wherein the tablet comprises at least one water-soluble polymer in the range of 0.1-80% w/w; and at least one active ingredient in the range of 0.1-95.5% w/w; said method comprising the following steps of:
admixing thoroughly of all the components including the at least one water soluble polymer and the at least one active ingredient;
compacting the admixture into tablet; and
curing the tablet so that the tablet may have water in the range of 0.1-30% w/w before it is applied to the water-based environment so that the at least one active ingredient will be released into the water-based environment in a sustained manner.

25. The method of claim 24, wherein the curing step is done by steaming the tablets unwrapped for a specified time in accordance with the size and dimension of the tablets and the type of the polymer used.

26. The method of claim 24, wherein the curing step is done by leaving the tablets unwrapped in an ambient environment with humidity for a specified time in accordance with the size and dimension of the tablets and the type of the polymer used.

27. A method for manufacturing a tablet for controlled release of at least one active ingredient into a water-based environment, wherein the tablet comprises at least one water soluble polymer in the range of 0.1-80% w/w; at least one active ingredient in the range of 0.1-95.5% w/w; and water in the range of 0.1-30% w/w; said method comprising the following steps of:
admixing thoroughly of all the components including the at least one water soluble polymer, the at least one active ingredient thoroughly, and water;
compacting the admixture into tablet; and
curing the tablet before it is applied to the water-based environment so that the at least one active ingredient will be released into the water-based environment in a sustained manner.

28. The method of claim 27, wherein the water may be added either in the form of pure water, water contained within the water-soluble polymer, or water contained within the active ingredient.

29. The method of claim 27, wherein the curing step includes wrapping up the tablets and leaving the wrapped tablets in an environment with an ambient temperature for a specified time in accordance with the size and dimension of the tablets and the type of the polymer used.

30. The method of claim 27, wherein the curing step includes wrapping up the tablets and heating the wrapped tablets for a specified time in accordance with the size and dimension of the tablets and the type of the polymer used.
